(19) United States
(12) Patent Application Publication
(10) Pub. No.: US 2021/0380316 A1
(43) Pub. Date: Dec. 9, 2021

(54) CANDLE COVER FOR BEVERAGE CONTAINER

(71) Applicant: Winson, LLC, Kenmore, WA (US)

(72) Inventors: Jason Gorske, Oak Grove, OR (US); Winslow Harte, Kenmore, WA (US)

(21) Appl. No.: 16/894,650

(22) Filed: Jun. 5, 2020

(51) Int. Cl. B65D 43/02; F21V 35/00; B65D 51/24

(52) U.S. Cl. CPC B65D 43/02; F21W 2121/002; B65D 51/245; F21V 35/00

(57) ABSTRACT

A candle cover for a beverage container can include a base portion having a top surface and a bottom surface, a candle-receiving portion extending upward from the top surface of the base portion, and one or more protrusions extending inward from a circumferential edge of the base portion. The candle-receiving portion can have at least one opening sized to receive a candle. Alternatively, a lower surface of the base portion can be substantially flat to be positioned on a rim of a beverage container.

### FIELD

This disclosure is related to celebratory beverage covers and, in particular, to candle covers for use with beverages containers of various shapes and sizes.

### BACKGROUND

Celebrations, such as birthday celebrations, often include candles. Conventionally, candles are positioned in, and supported by, food items such as cakes, cupcakes, and the like. Since not all celebrations have food items readily available and of the type that can easily receive a candle, there is a need for other systems and methods of holding and presenting a candle during a celebratory moment.

### SUMMARY

Various embodiments of candle covers for use with beverage containers (e.g., cans, pint glasses, etc.) are provided herein.

In one embodiment, a candle cover for a beverage container is provided. The candle cover comprises a base portion having a top surface and a bottom surface, a candle-receiving portion extending upward from the top surface of the base portion, and one or more protrusions extending inward from a circumferential edge of the base portion. The candle-receiving portion can include at least one opening sized to receive a candle.

In another embodiment, a method of placing a candle on a beverage container is provided. The method comprises providing a candle cover formed of silicone and comprising a base portion having a top surface and a bottom surface, securing the candle cover to the beverage container by positioning the bottom surface into contact with a rim of the beverage container, positioning a candle in an opening of a candle-receiving portion of the candle cover. The candle-receiving portion can extend upward from the top surface of the base portion.

In another embodiment, a candle cover for a beverage container is provided which includes a base portion having a top surface and a bottom surface and a candle-receiving portion extending upward from the top surface of the base portion. The candle-receiving portion comprises at least one opening sized to receive a candle and at least the base portion of the candle cover is formed from silicone.

In yet another embodiment, a method of placing a candle on a beverage container is provided. The method comprises providing a candle cover formed of silicone and comprising a base portion having a top surface and a bottom surface, securing the candle cover to the beverage container by positioning the bottom surface into contact with a rim of the beverage container, and positioning a candle in an opening of a candle-receiving portion of the candle cover. The candle-receiving portion can extend upward from the top surface of the base portion.

The foregoing and other objects, features, and advantages of the invention will become more apparent from the following detailed description, which proceeds with reference to the accompanying figures.

### BRIEF DESCRIPTION OF THE DRAWINGS

FIG. 1 shows a perspective view of an embodiment of a candle cover.

FIG. 2 shows a side view of the candle cover shown in FIG. 1.

FIG. 3 shows a top view of the candle cover shown in FIG. 1.

FIG. 4 shows a bottom view of the candle cover shown in FIG. 1.

FIG. 5 shows a perspective view of the candle cover shown in FIG. 1 secured to a beverage can.

FIG. 6 shows a side view of the candle cover shown in FIG. 5 secured to a beverage can.

FIG. 7 shows a perspective view of the candle cover shown in FIG. 1 secured to a beverage can and holding a candle.

FIG. 8 shows a side view of the candle cover shown in FIG. 7 secured to a beverage can and holding a candle.

FIG. 9 shows a perspective view of another embodiment of a candle cover.

FIG. 10 shows a top view of the candle cover shown in FIG. 9.

FIG. 11 shows a side view of the candle cover shown in FIG. 9.

FIG. 12 shows a bottom view of the candle cover shown in FIG. 9.

FIG. 13 shows a perspective view of the candle cover shown in FIG. 9 secured to another beverage container.

FIG. 14 shows a side view of the candle cover shown in FIG. 13 secured to another beverage container.

FIG. 15 shows a perspective view of the candle cover shown in FIG. 13 secured to secured to another beverage container and holding a candle.

FIG. 16 shows a side view of the candle cover shown in FIG. 13 secured to secured to another beverage container and holding a candle.

FIGS. 17A-D show various views of a candle cover.

FIGS. 18A-B show various views of a candle cover on a beverage container.

FIGS. 19A-B show various views of a candle cover with a candle on a beverage container.

FIGS. 20A-D show various views of a candle cover.

FIGS. 21A-B show various views of a candle cover on a beverage container that is a pint glass.

FIGS. 22A-B show various views of a candle cover with a candle on a beverage container that is a pint glass.

FIGS. 23A-B show various views of a candle cover on a beverage container that is a wine glass.

FIGS. 24A-B show various views of a candle cover with a candle on a beverage container that is a wine glass.

FIGS. 25A-B show various views of a candle cover on a beverage container that is a beer mug.

FIGS. 26A-B show various views of a candle cover with a candle on a beverage container that is a beer mug.

FIGS. 27A-B show various views of a candle cover on a beverage container that is a drink glass.

FIGS. 28A-B show various views of a candle cover with a candle on a beverage container that is a drink glass.

FIGS. 29A-D show various views of a candle cover.

FIGS. 30A-B show various views of a candle cover on a beverage container that is a champagne glass.

FIGS. 31A-B show various views of a candle cover with a candle on a beverage container that is a champagne glass.

FIGS. 32A-B show various views of a candle cover on a beverage container that is a shot glass.

FIGS. 33A-B show various views of a candle cover with a candle on a beverage container that is a shot glass.

### DETAILED DESCRIPTION

General Considerations

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Furthermore, as used herein, the term “and/or” means any one item or combination of items in the phrase. As used herein, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

As used herein, the term “candle cover” refers to a cover or lid for a container that can be removable received on a top surface of the container and which has at least one opening of holding a candle on the top surface thereof.

Exemplary Candle Covers and Methods of Using the Same

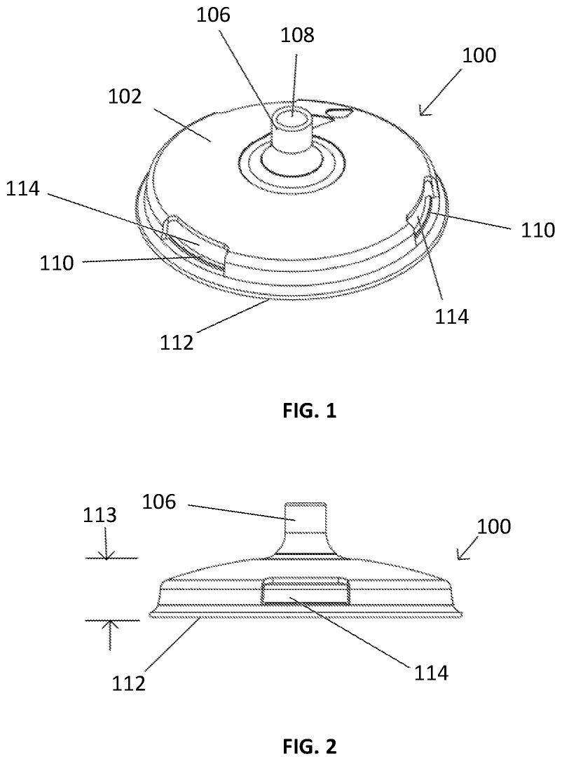

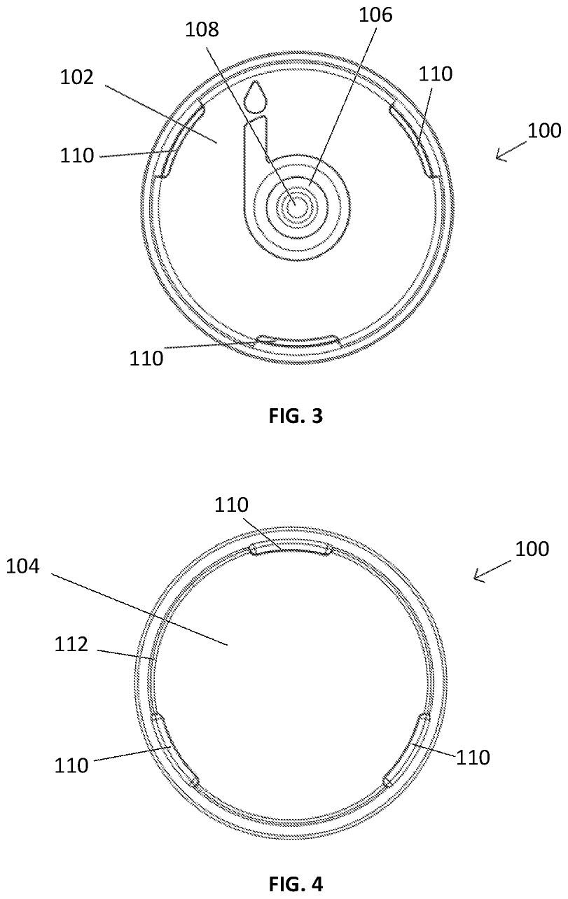

FIGS. 1-4 illustrate an exemplary candle cover 100 that can be secured to a conventional beverage can, such as a conventional single-use can for drinks. Candle cover 100 has a base that includes a top surface 102 and a bottom surface 104. Top surface 102 includes a candle-receiving portion 106. The candle-receiving portion 106 can be formed in any suitable manner or shape for receiving a candle. For example, the candle-receiving portion 106 shown in FIG. 1 extends upward from the top surface 102 to define an opening 108 into which a candle can be positioned.

Opening 108 can be sized to receive any size candle, including commonly used birthday candles which have a base diameter of about 3/16 inch. The opening 108 can extend into the candle-receiving portion 106 to define a cavity of a desired depth suitable to secure the candle therein. For larger candles, a wider opening and greater depth may be desirable to hold the candle in a secure manner.

In some embodiment, the selected material for the candle-receiving portion demonstrates at least some flexibility (e.g., silicone), such that the opening 108 can have the same diameter (or smaller) as a desired candle size. In this manner, the candle can be received and retained firmly by the cavity of the candle-receiving portion. Alternatively, the opening can be slightly larger in diameter than a desired candle, and a depth of the opening can be sufficient to maintain the candle in position.

Candle cover 100 can be formed of a flexible material so that it can bend, at least a little, to facilitate attachment to the beverage can. In some embodiments, the candle cover can be formed of a highly flexible material, such as silicone. In other embodiments, the candle cover can be formed of a less flexible material, such as plastic.

In some embodiments, as shown in FIG. 4, the opening 108 does not extend through the bottom surface 104 of the candle cover 100 to protect the beverage in the container from receiving any candle debris during use.

Candle cover 100 can have one or more securing members that are configured to secure the candle cover to the beverage can. In FIGS. 1-4, the securing members are protrusions 110 that extend inward from a lower circumferential edge 112. In some embodiments, the lower circumferential edge 112 is sized to be greater than the diameter of the top of the beverage can and the protrusions 110 extend inward from the lower circumferential edge 112 to define a circumference (at least in part) that is smaller than the diameter of the top of the beverage can. Because candle cover 100 is formed of a flexible material, the candle cover can bend to permit attachment. Alternatively, the candle cover can be formed of a hard (i.e., relatively inflexible) material and the protrusions can be configured to flex, either by the flexibility of the material or by the cantilever construction of the lip members.

As shown in FIG. 2, the lower circumferential edge 112 is spaced apart, vertically, from the candle-receiving portion. For example, a lower portion of the candle-receiving portion is at a height 113 relative the position of the lower circumferential edge 112. In some embodiments, height 113 is about half the height of the candle cover. In other embodiments height 113 is between ⅓ to ⅔ the height of the candle cover.

Protrusions 100 can comprise a plurality of protrusions that extend around the circumference of the candle cover. In some embodiments, there are at least two protrusions, in others there are at least three protrusions. In yet other embodiments, the plurality of protrusions can be continuous and extend completely around the circumference, thereby forming a single contiguous protrusion.

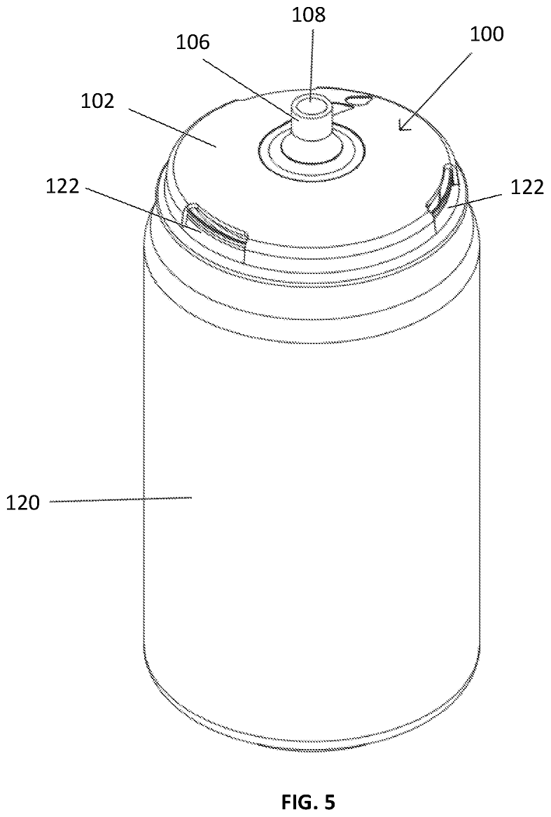

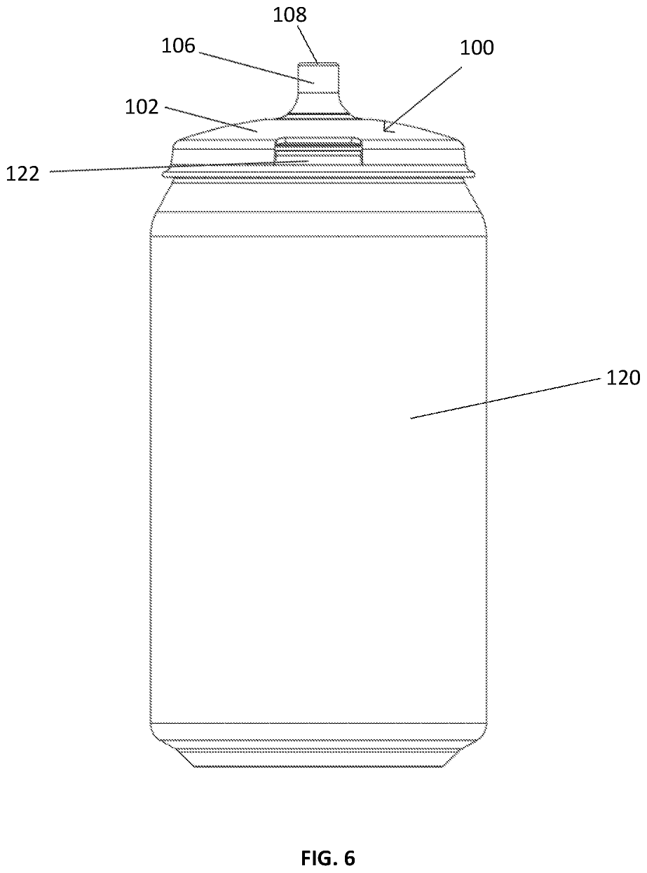

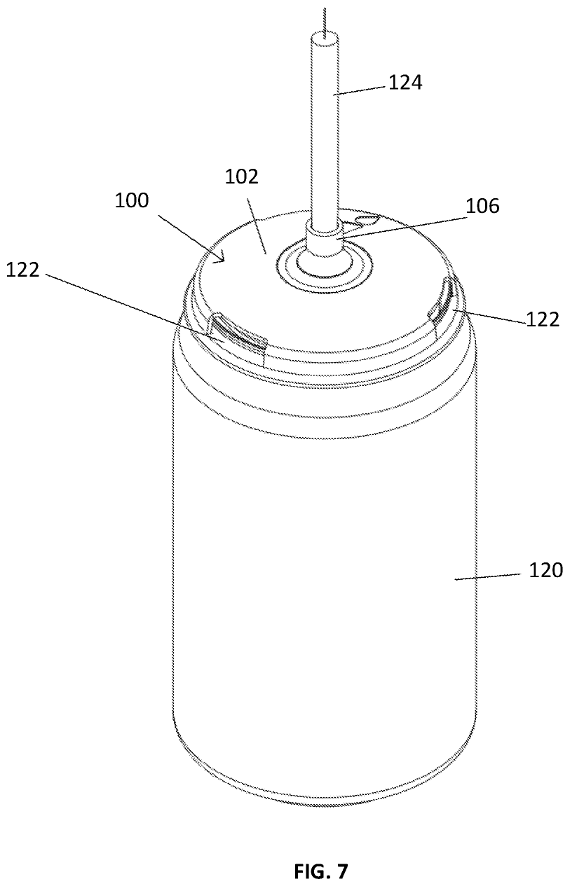

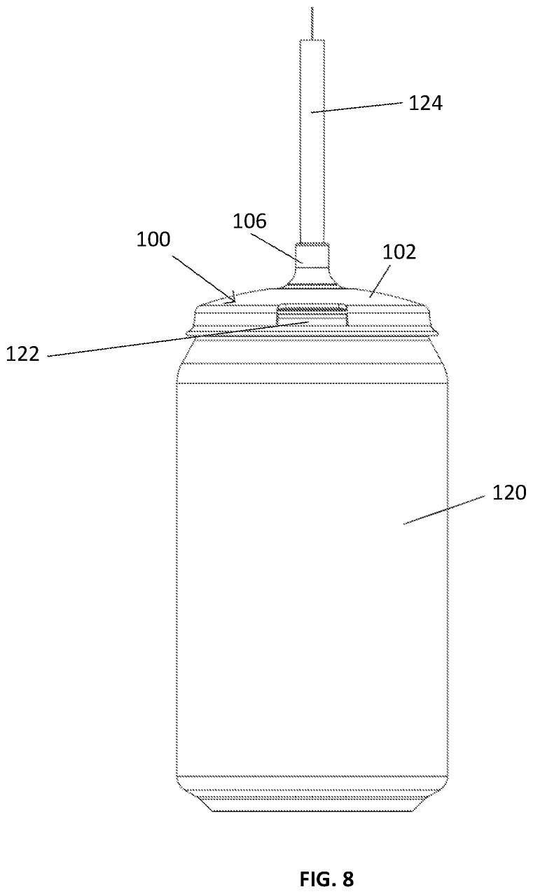

FIGS. 5 and 6 illustrate candle cover 100 attached to a beverage can 120. At the locations of the protrusions 110, a plurality of windows 114 can be provided in the candle cover 100. As shown in FIG. 2, windows 114 can be located, vertically, between lower circumferential edge 112 and the lower portion of the candle-receiving portion. As shown in FIG. 5, the location of the windows 114 identify the location of the protrusions and can facilitate removal over the candle cover 100 from the beverage can 120. For example, to remove the candle cover 100, one can grip the candle cover 100 below one or more of the windows 114 and pull the protrusions 110 outward from the beverage can 120. FIGS. 7 and 8 illustrate the candle cover 100 on beverage can 120 and including a candle 124 secured within opening 108.

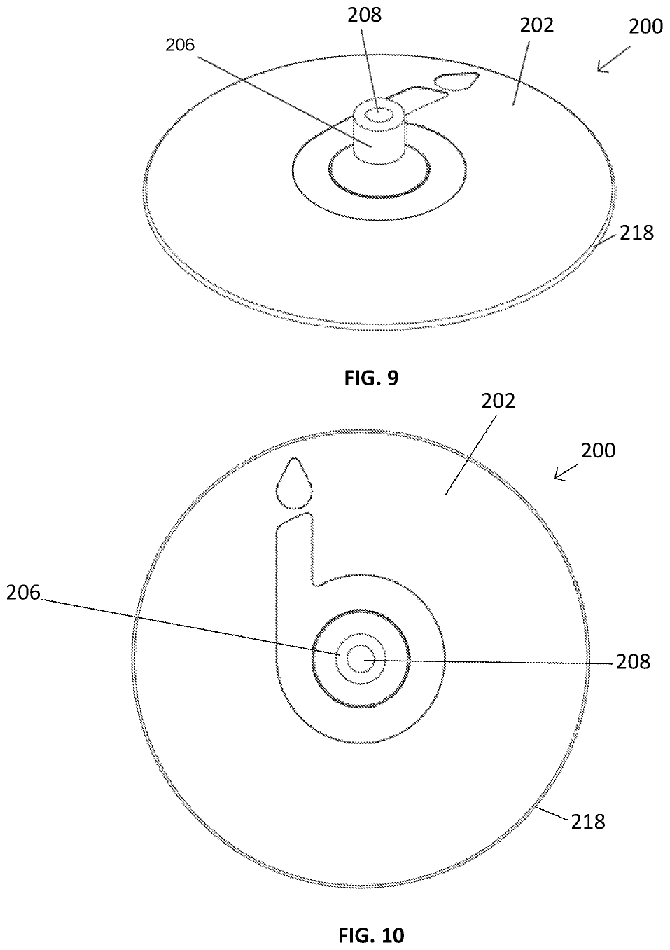

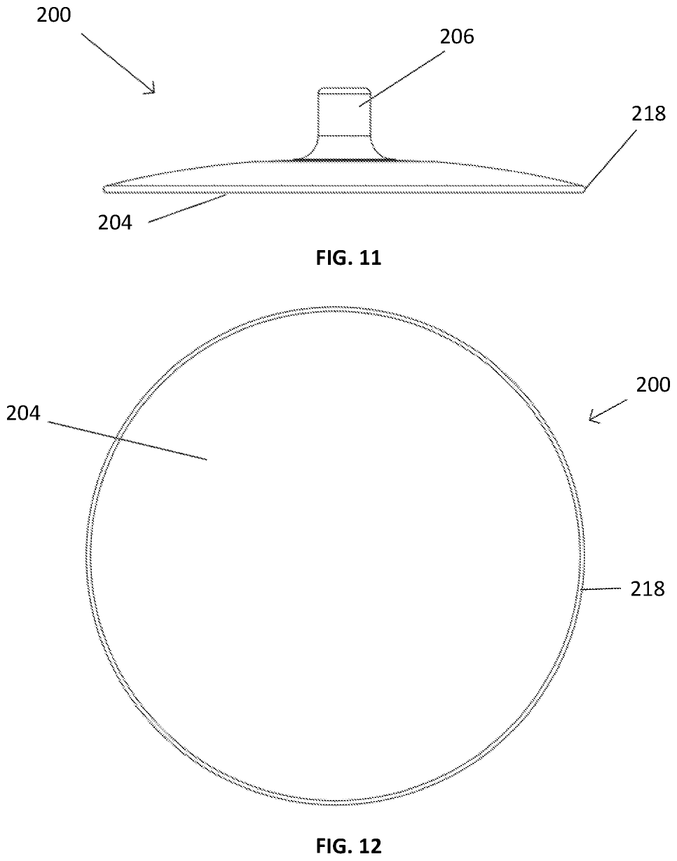

FIGS. 9-12 illustrate another exemplary candle cover 200. Candle cover 200 is configured to be received on any beverage surface or opening, such as a wine glass, pint glass, or even a conventional single-use can for drinks. Candle cover 200 has a top surface 202 and a bottom surface 204. Top surface 202 includes a candle-receiving portion 206. As with candle-receiving portion 106, candle-receiving portion 206 can be formed in any suitable manner or shape for receiving a candle. For example, the candle-receiving portion 206 shown in FIG. 9 extends upward from the top surface 202 to define an opening 208 into which a candle can be positioned.

As with the other openings disclosed herein, opening 208 can be sized to receive any size candle, including commonly used birthday candles which have a base diameter of about 3/16 inch. The opening 208 can extend into the candle-receiving portion 206 to define a cavity of a desired depth suitable to secure the candle therein. For larger candles, a wider opening and greater depth may be desirable to hold the candle in a secure manner.

Candle cover 200 is formed of a flexible material, such as silicone, and it gently attaches to the surface of the beverage container when it is placed on top. The flexible candle cover 200 provides a suction seal that is sufficient to hold the candle cover 200 in place but also easy to remove by simply pulling up on one side of the candle cover 200.

In some embodiments, as shown in FIG. 12, the opening 208 does not extend through the bottom surface 204 of the candle cover 200 to protect the beverage in the container from receiving any candle debris during use.

Candle cover 200 has an outer circumferential edge 218 that limits the size of the container that it can be used with. For example, in some embodiments, the outer circumferential edge 218 can be between 3.3 and 5.0 inches in diameter, between 3.5 to 4.0 inches, or between 4.0 to 5.0 inches, which is sufficient to cover a conventional pint glass (3.25 inches top diameter) and most wine and cocktail glasses (between 3.0-4.0 inches in top diameter).

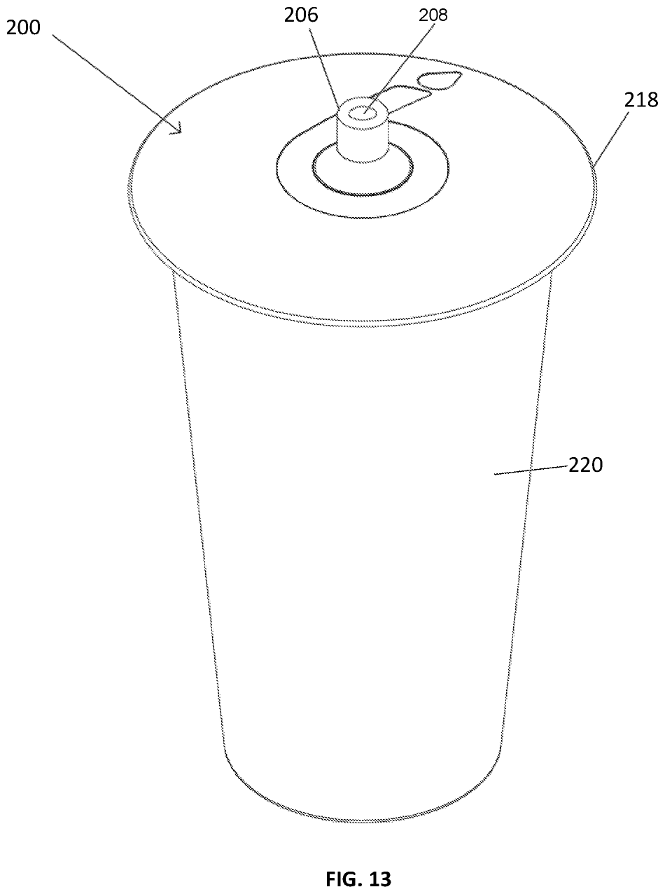

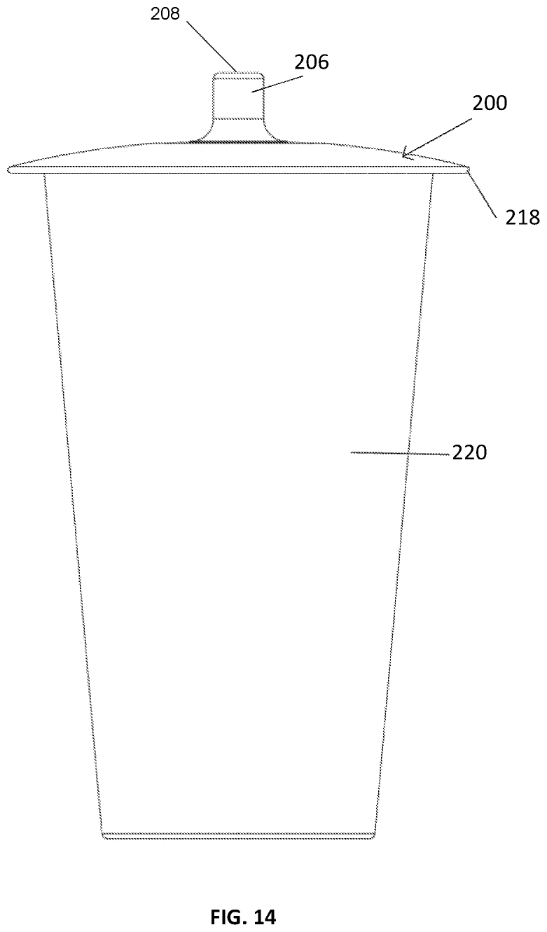

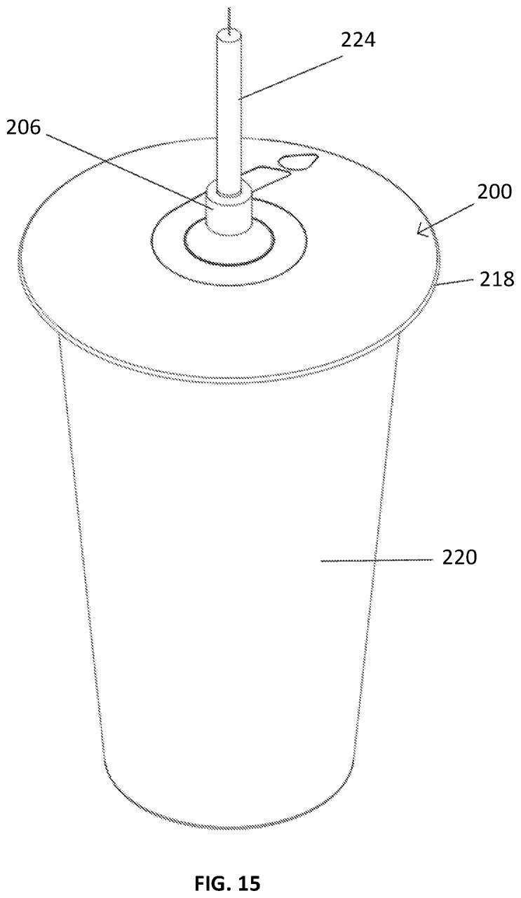

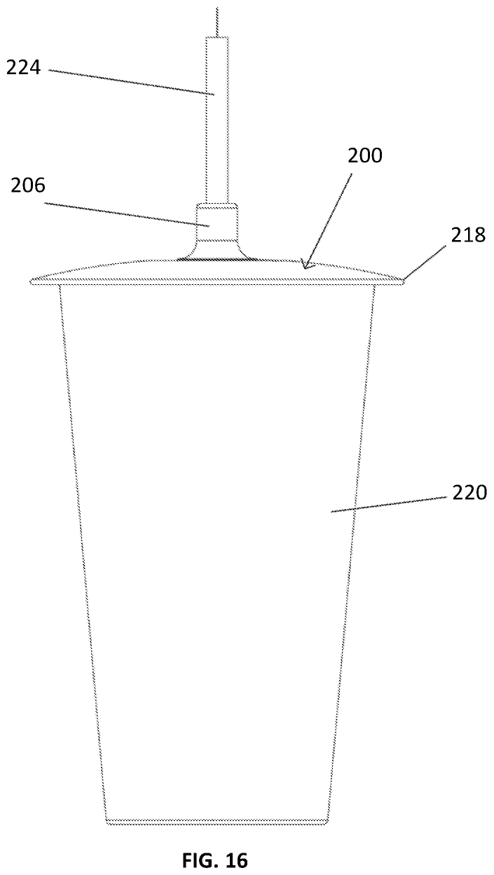

FIGS. 13 and 14 illustrate candle cover 200 on a top surface of a pint glass 220. As shown in FIG. 14, the outer circumferential edge 218 of candle cover 200 extends is larger than the top diameter of the container (e.g., pint glass). In some embodiments, the outer circumferential edge is selected to be between 105%-120%, or between 110-115% of the desired use (e.g., 105%-120% or 110%-115% of 3.25 inches for pint glasses). FIGS. 15 and 16 illustrate the candle cover 200 on beverage container 220 and including a candle 224 secured within opening 108.

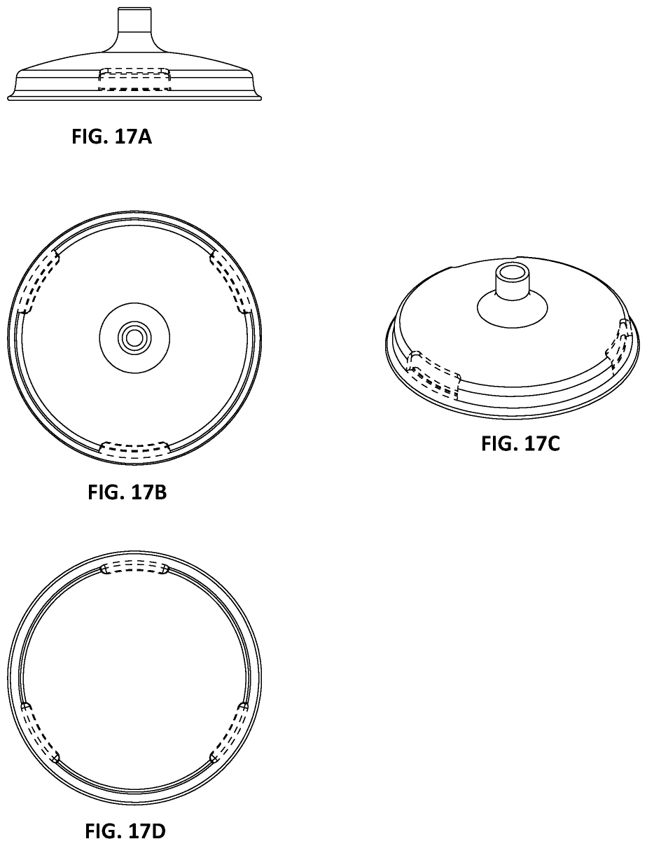

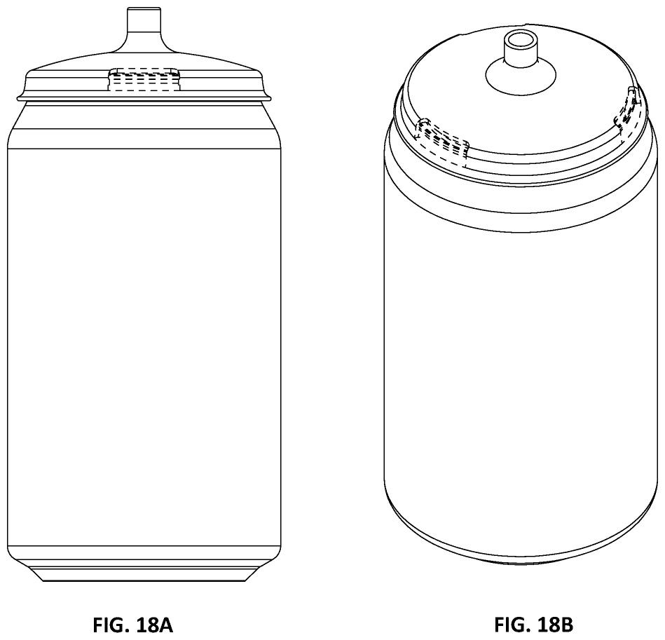

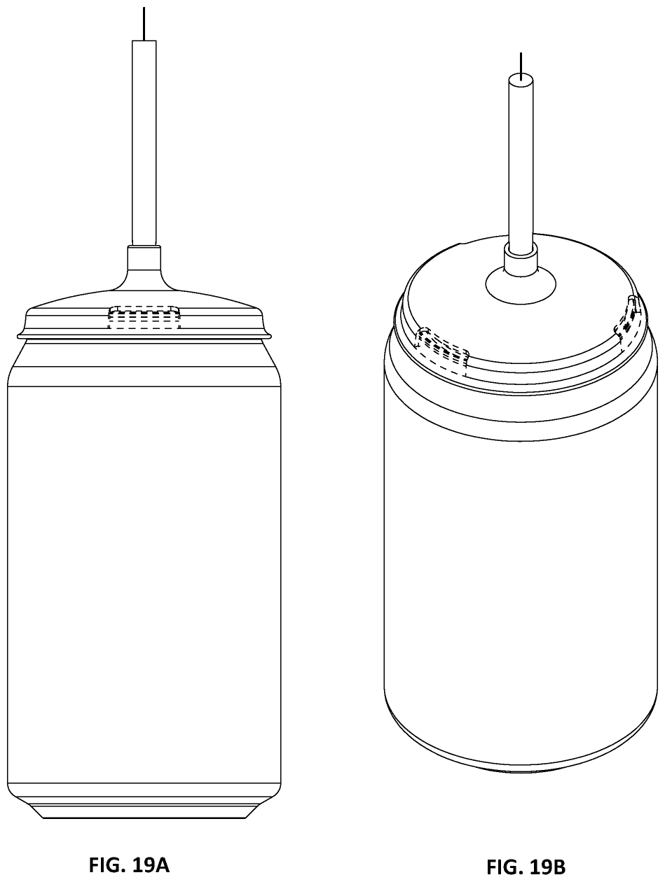

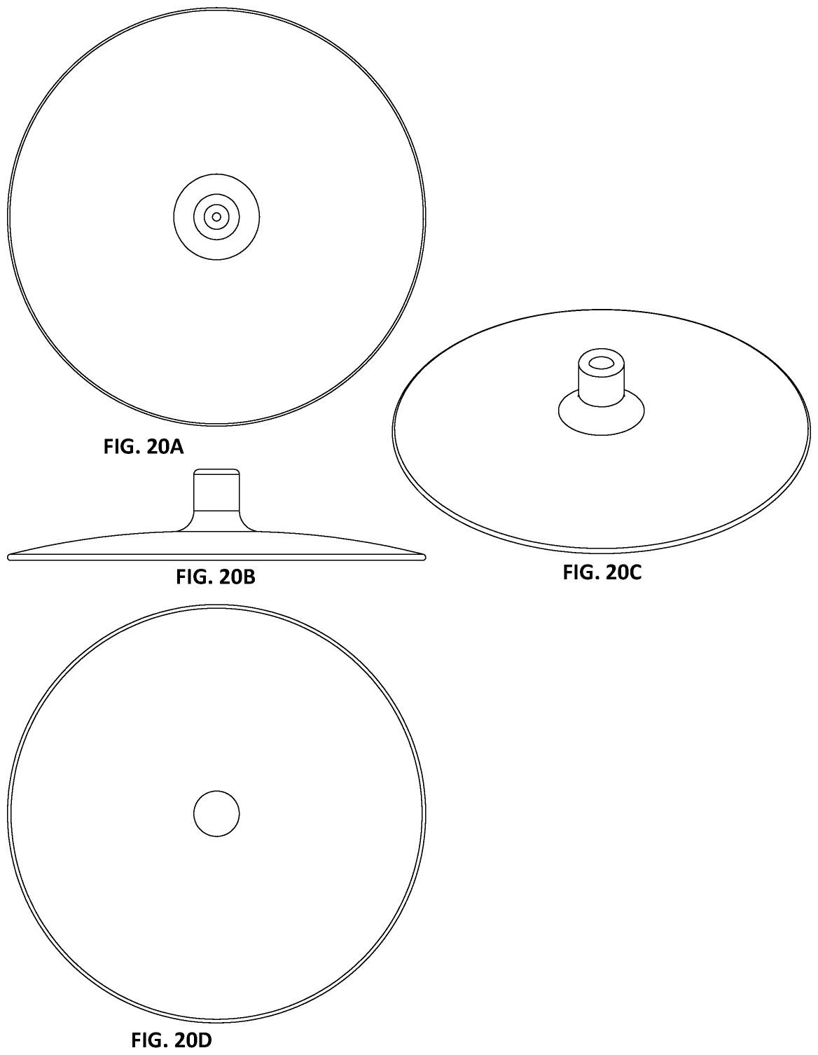

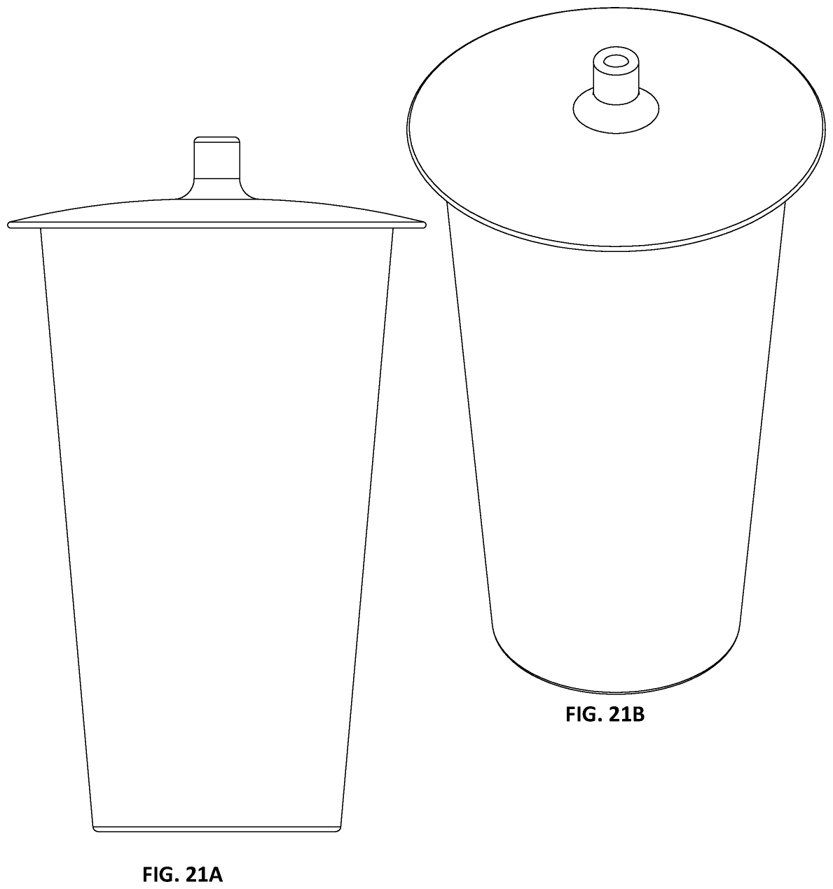

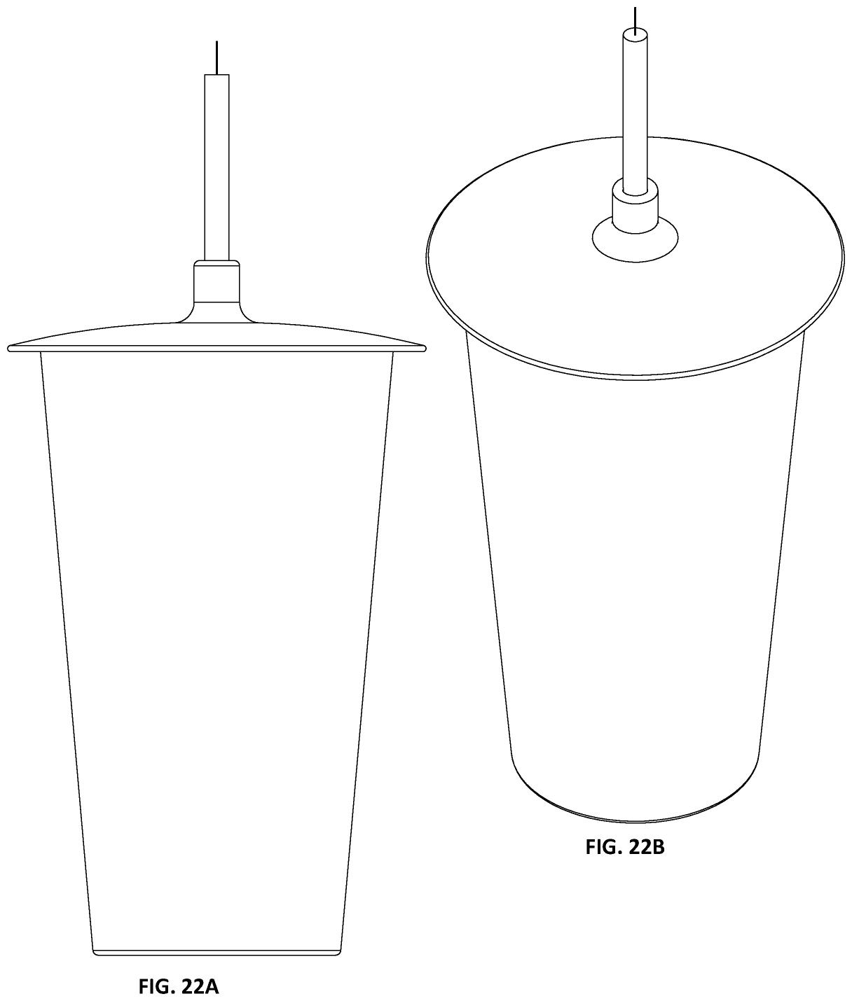

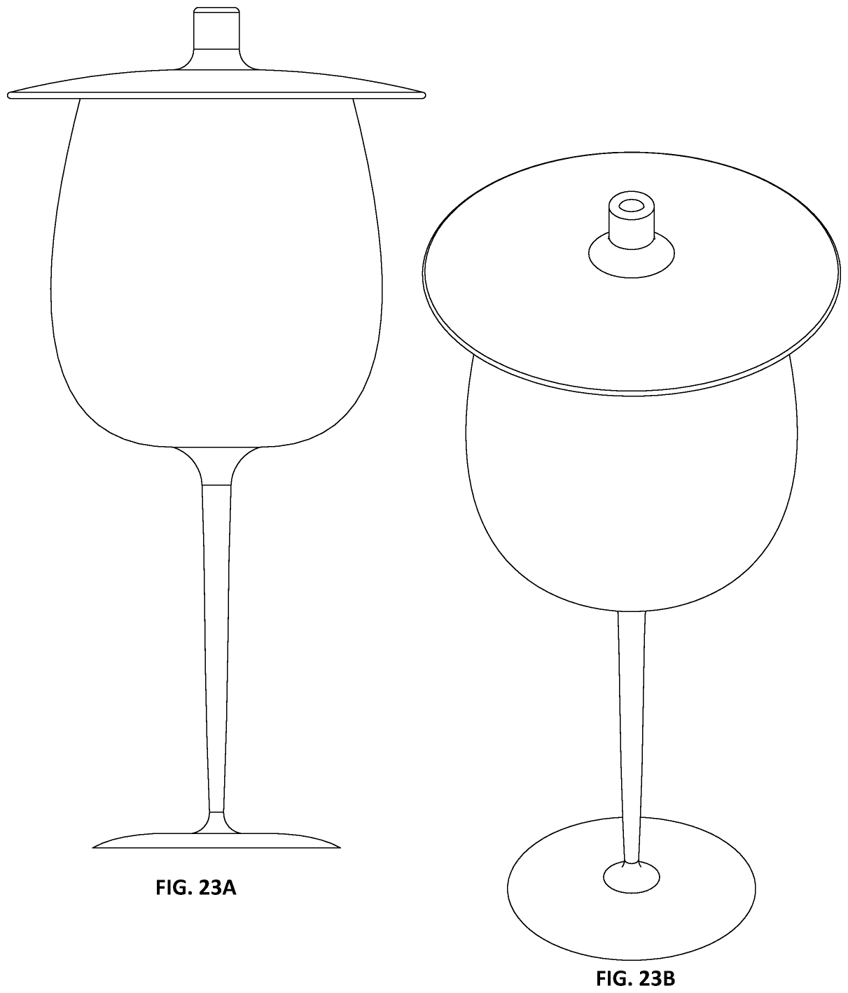

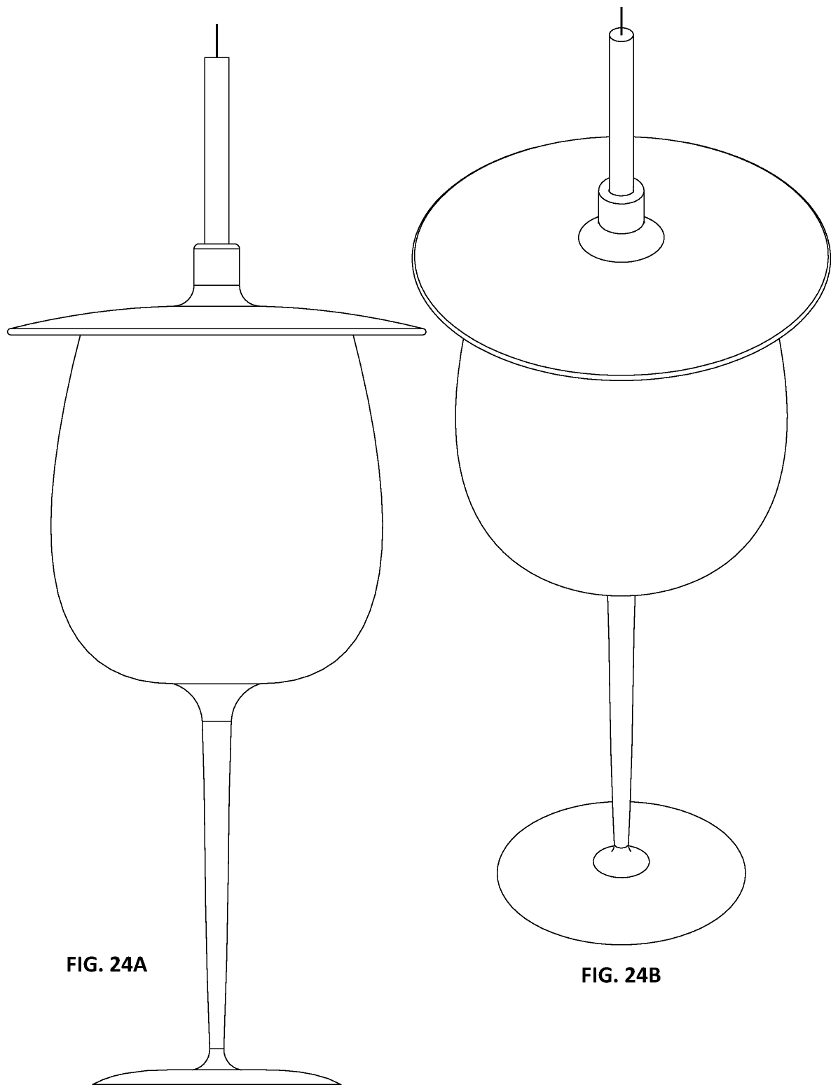

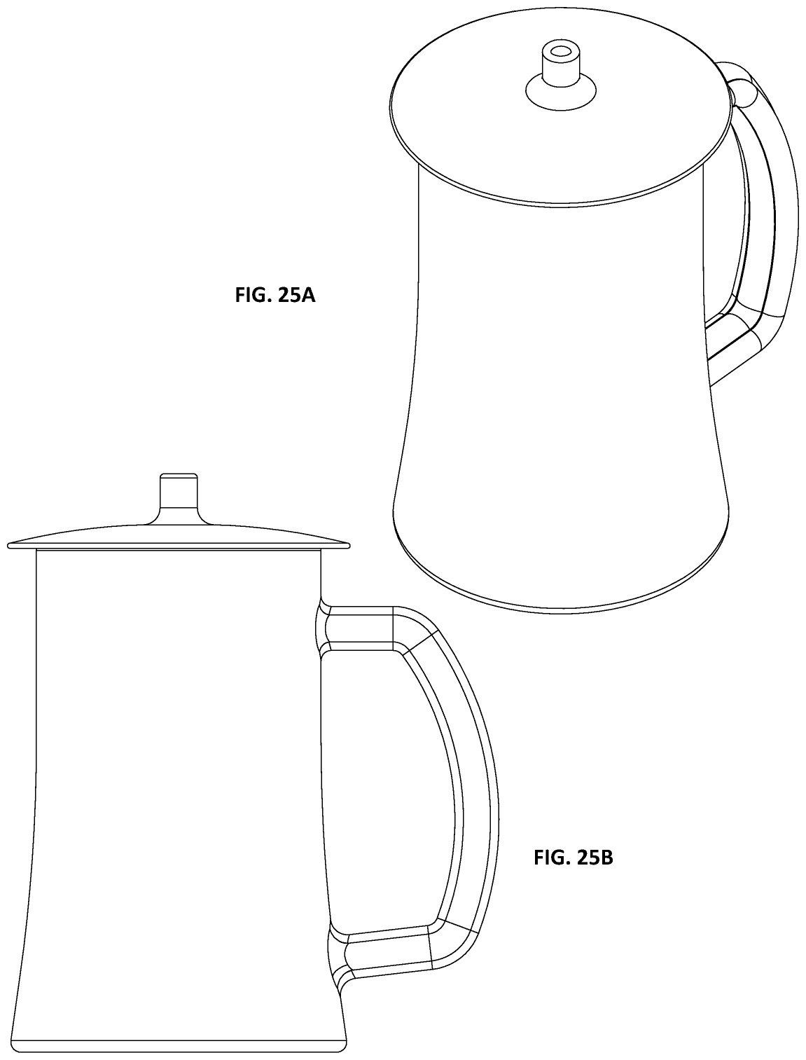

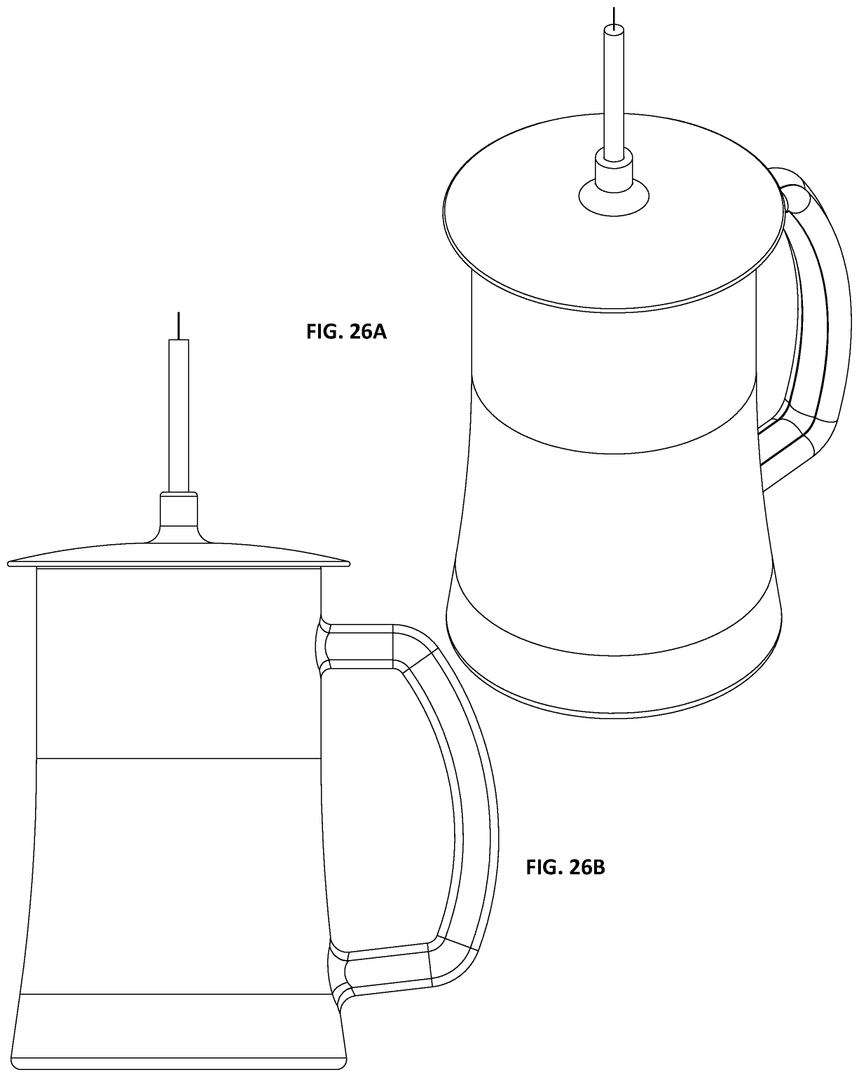

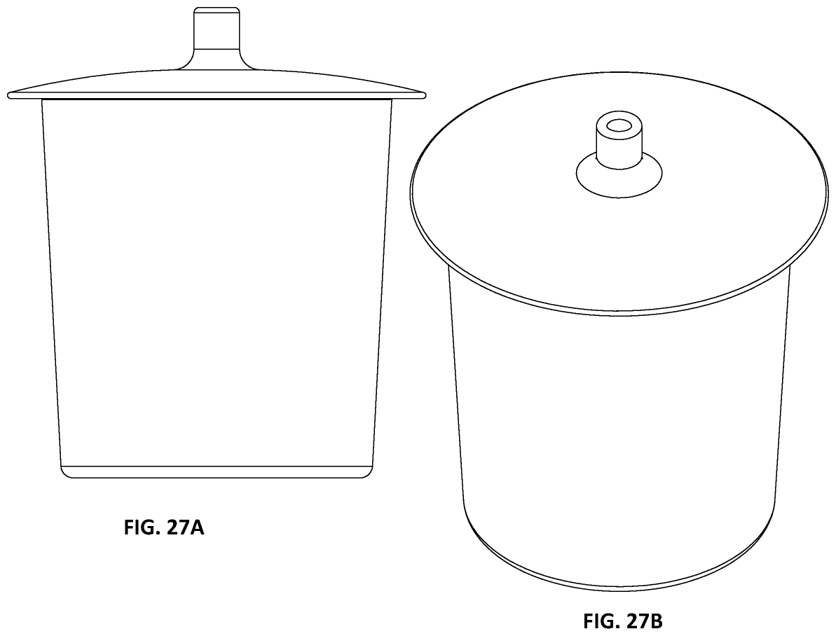

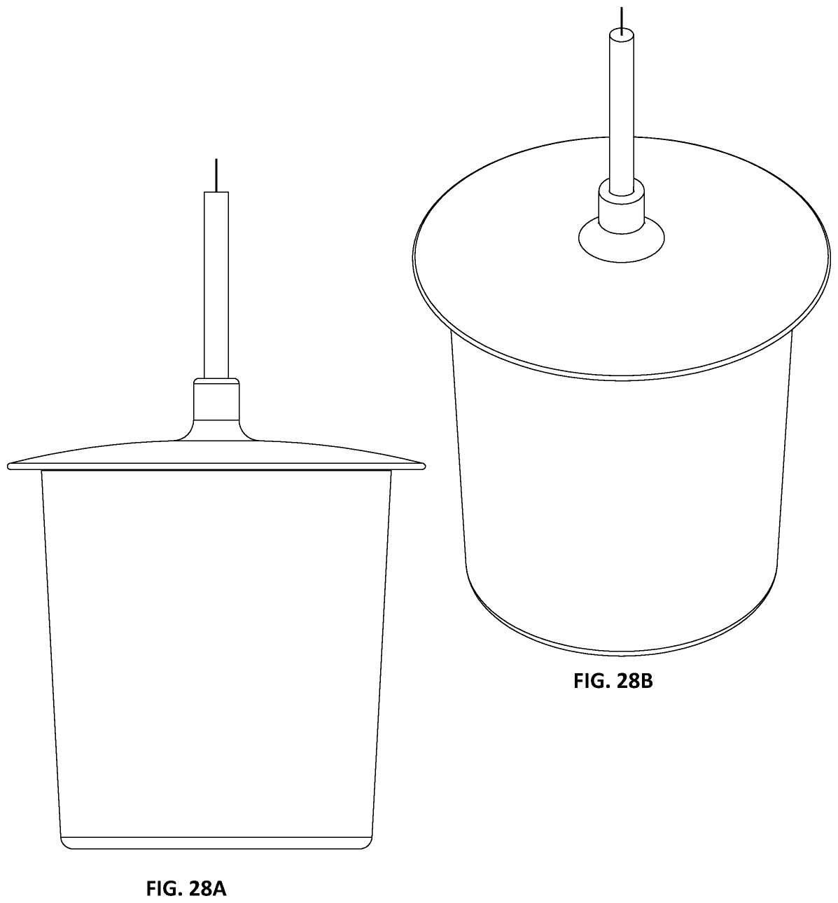

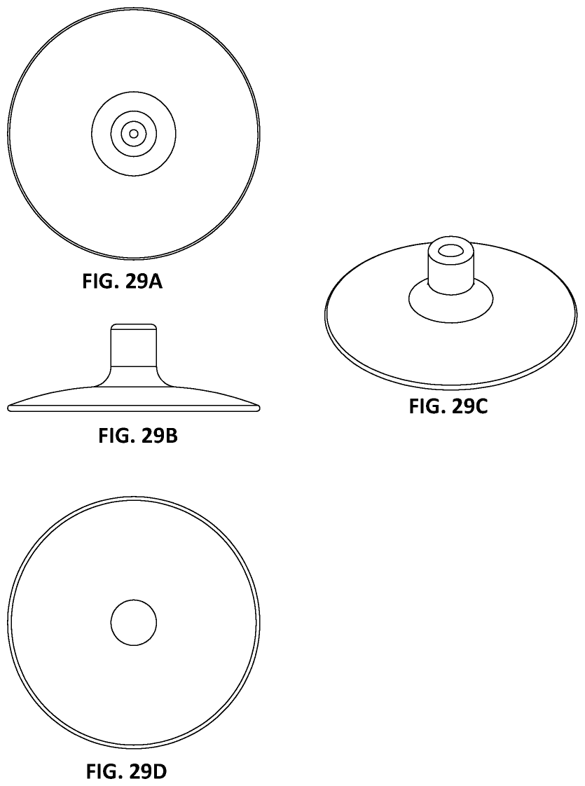

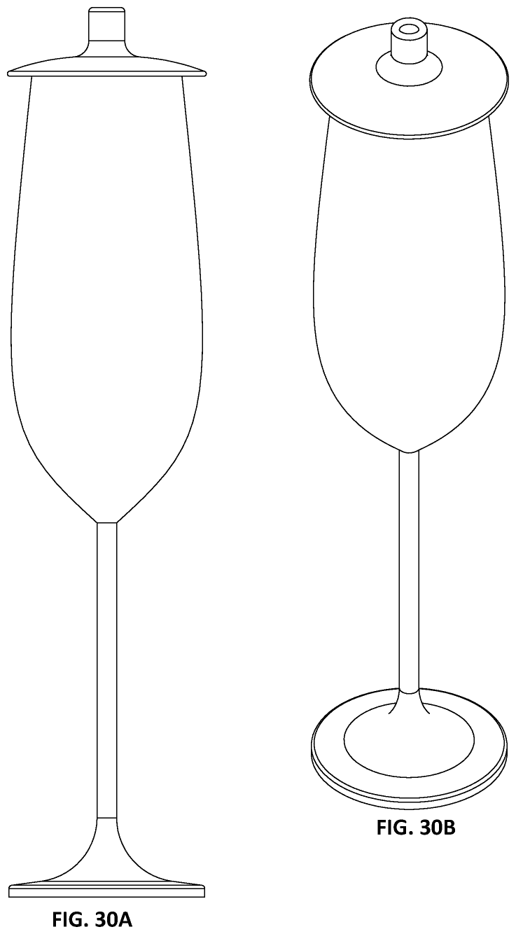

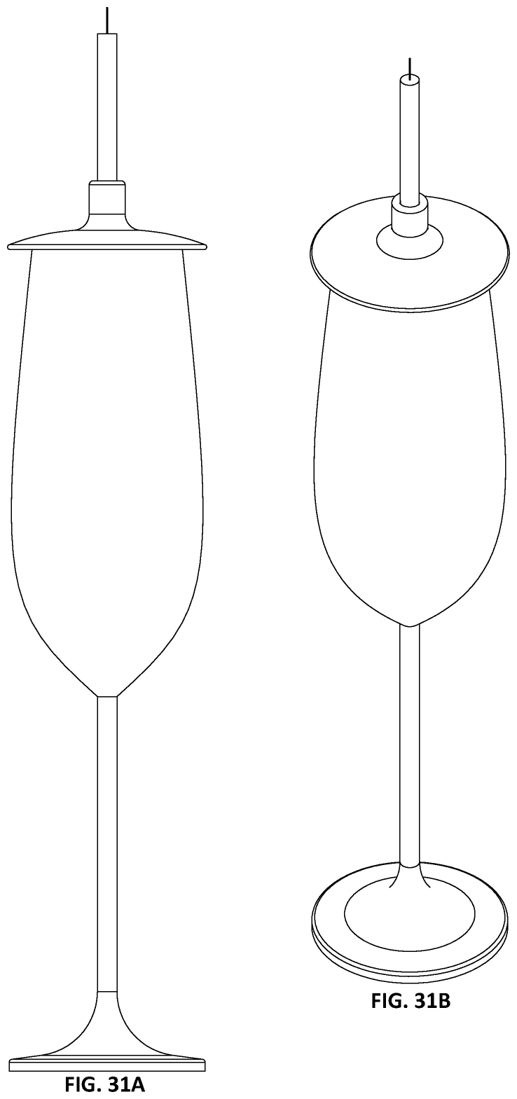

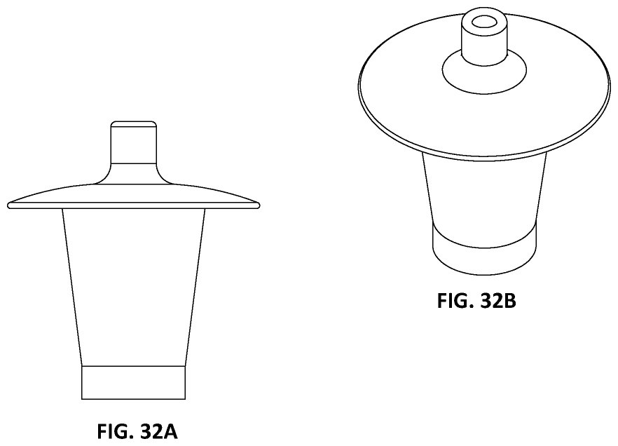

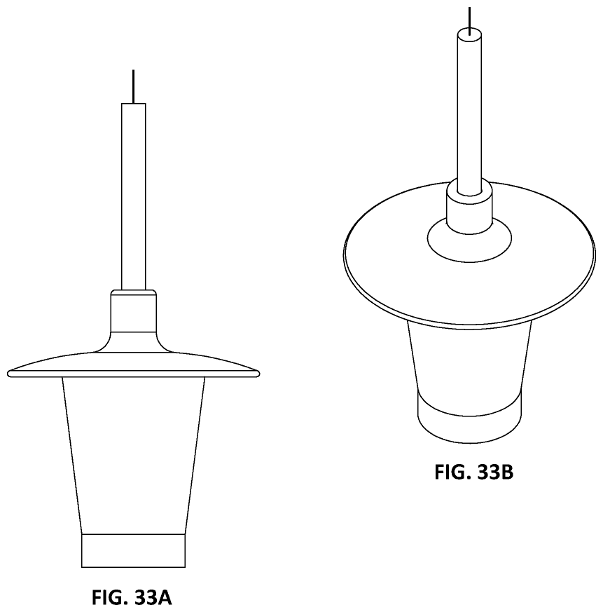

FIGS. 17-33 illustrate additional embodiments of a candle cover, including candle covers that can be used with wine glasses, champagne glasses, beer mugs, drink glasses, shot glasses, and other beverage containers.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A candle cover for a beverage container, the candle cover comprising:
a base portion having a top surface and a bottom surface;
a candle-receiving portion extending upward from the top surface of the base portion, the candle-receiving portion comprising at least one opening sized to receive a candle; and
one or more protrusions extending inward from a circumferential edge of the base portion.

2. The candle cover of claim 1, wherein the circumferential edge is at a first height of the base portion and the candle-receiving portion extends upward from base portion at a second height, the second height being greater than the first height.

3. The candle cover of claim 2, wherein the one or more protrusions comprise at least three protrusions that are spaced-apart around the circumferential edge.

4. The candle cover of claim 2, wherein the one or more protrusions comprise at a contiguous protraction that extends around the circumferential edge.

5. The candle cover of claim 2, wherein the base portion comprises one or more windows that are aligned with the one or more protrusions.

6. The candle cover of claim 5, wherein the one or more windows are located between the first height and the second height.

7. The candle cover of claim 5, wherein the first height is between ⅓ and ⅔ of a total height of the candle cover.

8. The candle cover of claim 1, wherein the candle cover is formed from a flexible material.

9. The candle cover of claim 8, wherein the candle cover is formed from silicone.

10. The candle cover of claim 8, wherein the candle cover is formed from plastic.

11. The candle cover of claim 1, wherein the candle-receiving portion defines a cavity that extends from the opening to a bottom surface of the cavity.

12. A candle cover for a beverage container, the candle cover comprising:
a base portion having a top surface and a bottom surface; and
a candle-receiving portion extending upward from the top surface of the base portion, the candle-receiving portion comprising at least one opening sized to receive a candle;
wherein at least the base portion of the candle cover is formed from silicone.

13. The candle cover of claim 12, wherein the base portion has an outer circumferential edge that has a diameter of between 3 and 5 inches.

14. The candle cover of claim 12, wherein the candle-receiving portion defines a cavity that extends from the opening to a bottom surface of the cavity.

15. A method of placing a candle on a beverage can, the method comprising:
providing a candle cover comprising a base portion having a top surface, a bottom surface, and one or more protrusions extending inward from a circumferential edge of the base portion;
securing the candle cover to the beverage can by positioning the bottom surface into contact with a rim of the beverage can and applying pressure to the top surface of the candle cover to cause the one or more protrusions to engage with a surface of the beverage can below the rim; and
positioning a candle in a candle-receiving portion of the candle cover,
wherein the candle-receiving portion extends upward from the top surface of the base portion.

16. The method of claim 15, wherein the one or more protrusions comprise at least three protrusions that are spaced-apart around the circumferential edge.

17. The method of claim 15, wherein the one or more protrusions comprise at a contiguous protraction that extends around the circumferential edge.

18. The method of claim 15, wherein the base portion comprises one or more windows that are aligned with the one or more protrusions and the method further comprises:
removing the candle cover from the beverage can by applying outward pressure to the candle cover below the one or more windows.

19. The method of claim 18, wherein the candle cover is formed from a flexible material that deforms at a location below the windows when the outward pressure is applied.

20. The method of claim 19, wherein the candle cover is formed from silicone.

21. A method of placing a candle on a beverage container, the method comprising:
providing a candle cover formed of silicone and comprising a base portion having a top surface and a bottom surface;
securing the candle cover to the beverage container by positioning the bottom surface into contact with a rim of the beverage container; and
positioning a candle in an opening of a candle-receiving portion of the candle cover,
wherein the candle-receiving portion extends upward from the top surface of the base portion.

22. The method of claim 21, wherein the base portion has an outer circumferential edge that has a diameter of between 3 and 5 inches, and the candle-receiving portion defines a cavity that extends from the opening to a bottom surface of the cavity.
